(19) United States
(12) Patent Application Publication
(10) Pub. No.: US 2014/0242328 A1
(43) Pub. Date: Aug. 28, 2014

(54) Measuring Device

(71) Applicants: Sergej Lopatin, Lorrach (DE); Ralf Leisinger, Wieslet (DE); Ralf Reimelt, Freiburg (DE); Peter Klofer, Steinen (DE)

(72) Inventors: Sergej Lopatin, Lorrach (DE); Ralf Leisinger, Wieslet (DE); Ralf Reimelt, Freiburg (DE); Peter Klofer, Steinen (DE)

(21) Appl. No.: 14/346,759

(22) PCT Filed: Aug. 23, 2012
(86) PCT No.: PCT/EP2012/066405

§ 371 Date: Mar. 24, 2014

(30) Foreign Application Priority Data
Sep. 23, 2011 (DE) 10 2011 083 333.1

(51) Int. Cl. G01D 11/00

(52) U.S. Cl. CPC G01D 11/00
USPC 428/119; 427/58; 216/13

(57) ABSTRACT

A measuring device having at least one corrosion resistant, process-facing surface, wherein at least one joint between a component of an electrically conductive material and a component of an electrically insulating material is sealed with a sealing structure, and wherein the process-facing surface is provided with a coating in such a manner that at least the sealing structure, a transitional region between the conductive component and the sealing structure and a transitional region between the insulating component and the sealing structure are covered by the coating.

The present invention relates to a measuring device, whose process-facing surface is composed sectionally of an electrically conductive material and sectionally of an electrically insulating material. The measuring device is, for example, a pressure sensor, a capacitive or conductive, fill-level measuring device, a microwave barrier for detecting a limit level or a radar, fill level measuring device.

An immense number of measuring devices are available for monitoring process variables of processes. Often, these are exposed to demanding conditions in their applications, conditions such as large temperature fluctuations or the presence of aggressive media. Simultaneously, frequently high requirements are placed on the reliability of the measured value determinations, material resistance and hygiene. Measuring devices are, in general, constructed of a plurality of different components. Also, the section of the measuring device contacting the process medium can itself be constructed of a plurality of components. For example, a measuring device for capacitive fill level measurement has a probe introducible into a container, which probe is constructed of a metal housing, at least one electrode, and at least one insulating element for galvanic isolation of electrode and housing. In such case, a sealed connection between the individual components is important, in order to prevent penetration of moisture or liquid, which could lead to corrosion.

Various materials can serve as insulating material. Examples include synthetic material (e.g. plastics), glass or ceramic. A disadvantage of an insulation composed of a synthetic material is the possibility of plastic deformation at high temperatures and the great differences between the thermal coefficients of expansion of metal and synthetic material. In this way, gaps can arise between metal parts and plastic parts, into which gaps process medium can penetrate and lead to corrosion. In the case of a measuring device provided in a container, this lack of sealing can bring about leakage, since process medium can escape through the measuring device into the environment outside of the container. Moreover, there is the opportunity that bacteria can enter into the gap, an event that is especially to be prevented in the case of hygienic applications. An insulation of glass is, in contrast, susceptible to glass corrosion, especially in the case of contact with liquids that have a high pH-value.

Due to their high durability, ceramics are especially suited as insulating material. Furthermore, the expansions of ceramic and metal can be adapted to one another by suitable choice of dimensions while taking into consideration their respective thermal coefficients of expansion. Such a temperature compensated, coaxial construction is described in the Offenlegungsschrift, DE 102010001273 A1.

Most often, ceramic parts and metal parts are connected with one another via an active solder, or braze, material. If, however, the surface of such a construction is in contact with an electrolyte, likewise corrosion effects can occur. Thus, the solder and the metal parts can create galvanic corrosion (battery effect).

An object of the invention is to provide a corrosion resistant connection between parts of a measuring device composed, respectively, of an electrically conductive material and an electrically insulating material.

The object is achieved by a measuring device having at least one corrosion resistant, process-facing surface, wherein at least one joint between a component of an electrically conductive material and a component of an electrically insulating material is sealed with a sealing means, and wherein the process-facing surface is provided with a coating in such a manner that at least the sealing means, a transitional region between the conductive component and the sealing means and a transitional region between the insulating component and the sealing means are covered by the coating.

In an embodiment, the coating comprises a transition metal, especially tantalum, gold, platinum, zirconium, titanium, as well as compounds of the transition metals, especially oxides, nitrides, fluorides.

The coating covers the critical locations of the connection between conductive component and sealing means, as well as the connection between insulating component and sealing means. The sealing means itself is likewise coated, so that the process medium does not come in contact with the sealing means. Because of the coating, the process medium cannot penetrate into the joint between the conductive and insulating components. For example, condensation of moisture and penetration of air are prevented.

Tantalum, for example, has an especially high resistance to corrosion. Moreover, tantalum is well reducible on a hot surface and, consequently, suitable to be a coating.

In another embodiment, the coating comprises an element of the carbon group, especially carbon, silicon, diamond-like carbon (DLC), as well as compounds of the carbon group, especially silicon carbide SiC.

Advantageous with SiC is its polymorphism, especially its tetrahedral nature. Furthermore, SiC is oxidation resistant due to its forming a passivating layer of silicon dioxide SiO₂. Additionally, it has a relatively high hardness and good adhesion. Since SiC is structurally and crystallographically similar to diamond, it combines well with diamond and diamond-like carbon compounds in coatings.

In another embodiment, the coating can be polycrystalline, amorphous, partially crystalline, or textured.

In a first embodiment, the electrically conductive component is composed of a metal, a metal alloy or a conductive ceramic. For example, the electrically conductive component is manufactured of stainless steel, titanium, Invar or Kovar. The electrically conductive component of the measuring device is, for example, an electrode or a housing.

In an additional embodiment, the insulating component is composed of a ceramic material. Preferably, the ceramic material is an aluminum oxide ceramic. The component of insulating material is, for example, insulation for galvanic isolation of two conductive components, e.g. two electrodes. It can, however, also be a component having a measuring function, for example, a membrane, or diaphragm, of a pressure sensor.

In an embodiment, the sealing means is a solder, or braze, or a glass.

The invention is furthermore achieved by a method for manufacturing a corrosion resistant, process-facing surface of a measuring device, wherein at least one joint between a component of an electrically conductive material and a component of an electrically insulating material is sealed with a sealing means, and wherein the process-facing surface is provided with a coating in such a manner that at least the sealing means, a transitional region between the conductive component and the sealing means and a transitional region between the insulating component and the sealing means are covered by the coating.

The method of the invention enables not only the manufacture of a corrosion resistant connection between two components separated by a sealed joint, but also the manufacture of a vacuum tight connection of the same.

In a first embodiment of the method, the process-facing surface is completely coated in a first step and the coating sectionally removed in a second step, so that the insulating component is at least sectionally free of the coating. The insulating component is thus completely or partially not coated with the coating. Components of an electrically conductive material conductively connected with one another via the coating and separated from one another by the insulating component are galvanically isolated from one another by the sectional removal of the coating.

In an embodiment, the coating is sectionally removed by removing material of the coated insulating component. For this, the insulating component is produced equipped with sacrificial rises, which are then, after the coating process, removed along with the coating. For example, the sacrificial rises are ground off or removed using some other mechanical method.

In an embodiment, the coating is sectionally removed by etching. In this embodiment, no material of the insulating component is removed, but, instead, only the coating is selectively removed.

In another embodiment of the method, only the process-facing surface of the sealing means, the transition region between the conductive component and the sealing means and the transition region between the insulating component and the sealing means are selectively coated. For example, the selective coating occurs by applying a mask on the process-facing surface and, thus, in the coating, only the surfaces not covered by the mask are coated.

An embodiment provides that a coating between 5 and 100 micrometers thick is produced. Preferably, the thickness of the coating lies between 30 and 50, especially about 40, micrometers, in the case of deposition of the coating from a gas phase.

In an additional embodiment of the method, the coating comprises a transition metal, especially tantalum, gold, platinum, zirconium, titanium, as well as compounds of the transition metals, especially oxides, nitrides, fluorides. Coating with tantalum occurs preferably by depositing tantalum from a gas phase by thermal decomposition of one or more tantalum halides.

In an embodiment, the coating comprises an element of the carbon group, especially carbon, silicon, diamond-like carbon (DLC), as well as compounds of the carbon group, especially silicon carbide, SiC. SIC coatings increase chemical resistance and shock, or impact, resistance and are additionally also hydrophobic, whereby they can serve well as anti-stick coatings, and have a low surface energy. Furthermore, SiC and DLC are combinable in a single layer, whereby the physical properties, such as surface energy and water repellence, respectively water diffusion, can be optimized advantageously as a function of composition.

Advantageous in the case of carbon and carbon compounds is their maximum hardness and maximum wear resistance combined with low coefficient of friction.

In another embodiment, the coating is polycrystalline, amorphous, partially crystalline, or textured.

In another embodiment of the method, the coating is produced using the CVD (Chemical Vapor Deposition) and/or PVD (Physical Vapor Deposition) method.

The invention will now be explained in greater detail based on the appended drawing, the figures of which show, in each case, schematically, as follows:

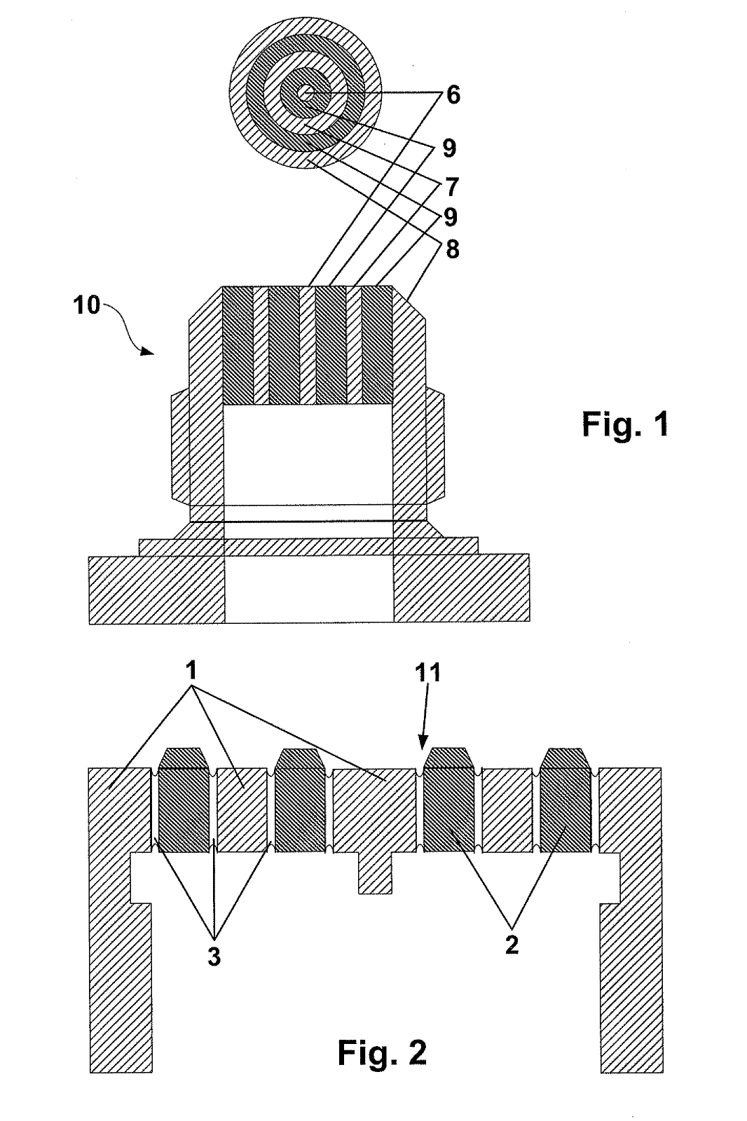

FIG. 1 a probe of a capacitive/conductive, fill level measuring device;

FIG. 2 a sectional illustration of the process-near part of a probe as in FIG. 1;

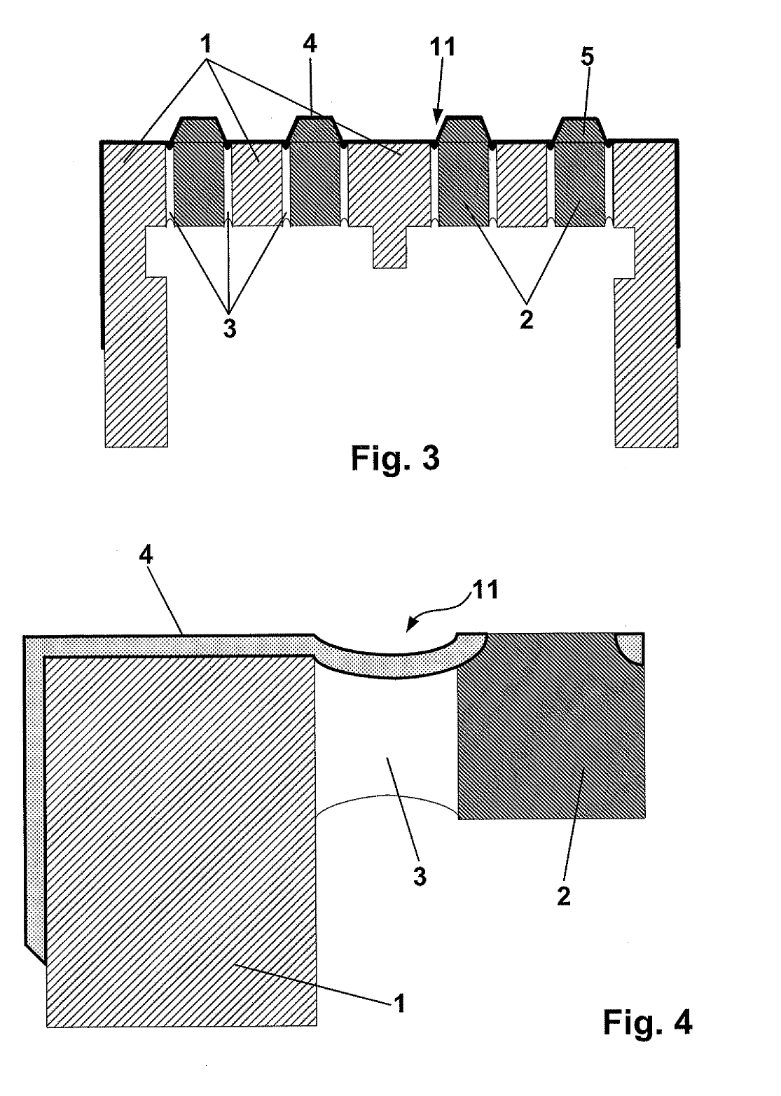

FIG. 3 a sectional illustration of the process-near part of the probe of FIG. 1 with coating of the process-facing surface;

FIG. 4 a section of the sectional illustration with sectionally coated surface;

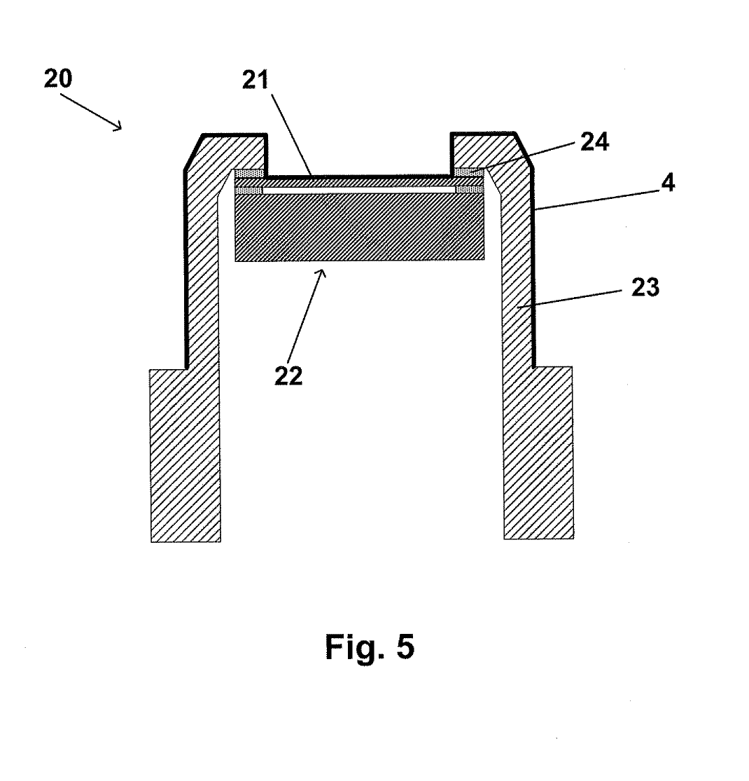

FIG. 5 a pressure sensor;

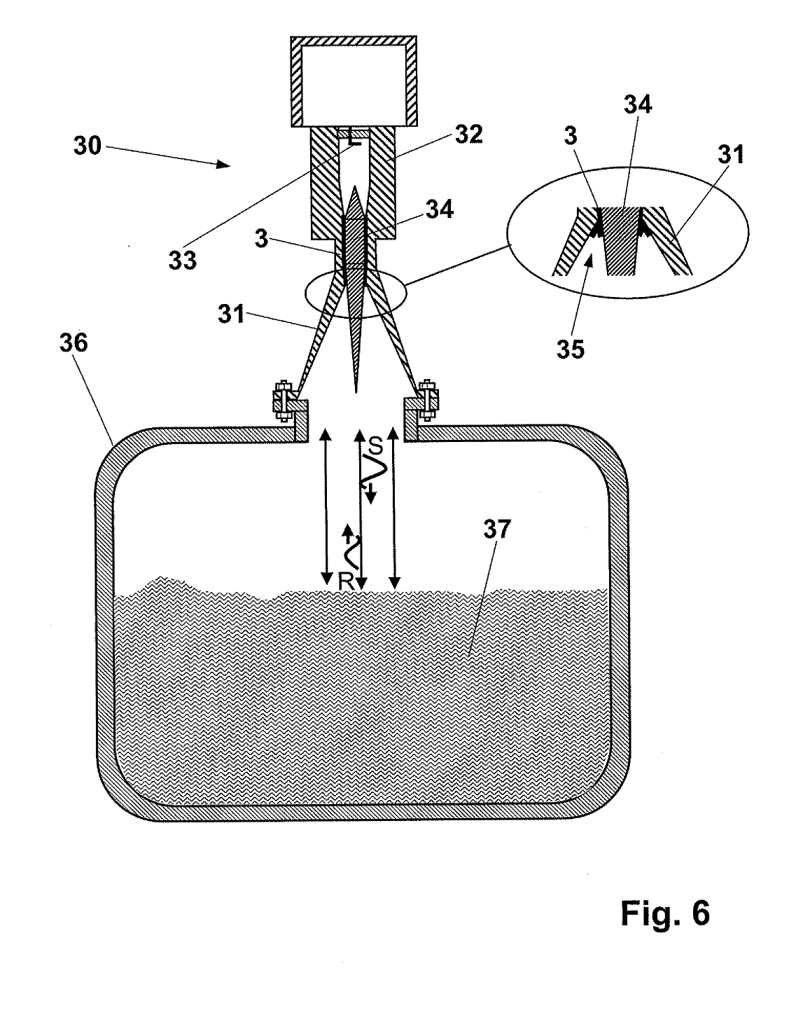

FIG. 6 a radar measuring device for fill level measurement; and

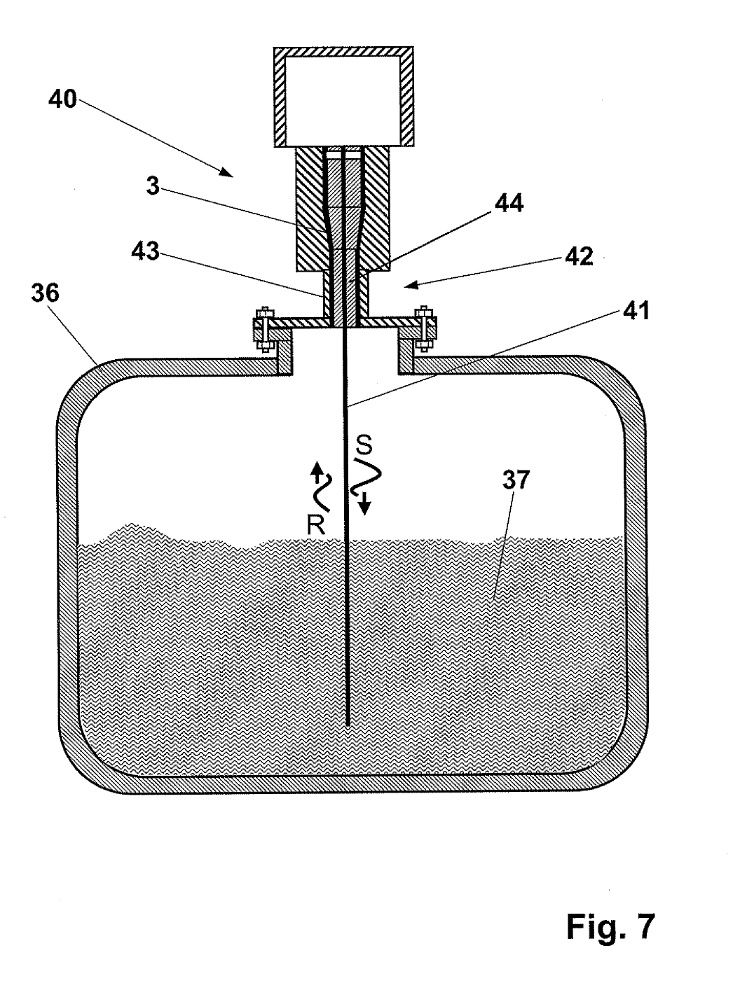

FIG. 7 a measuring device utilizing guided radar.

FIG. 1 shows, schematically, longitudinal and cross sections through a probe 10 for capacitive or conductive, fill level measurement. Such a probe 10 is flushly mountable, at the fill level height to be monitored, into the wall of the container, in which the fill substance is located. Probe 10 has a coaxial construction of probe electrode 6, insulation 9, guard electrode 7, further insulation 9 and housing 8. For capacitive measuring, the probe electrode 6 is supplied with an electrical, alternating voltage signal and the capacitance between probe electrode 6 and housing 8, respectively container wall, is measured. The guard electrode 7 is supplied with the same signal as the probe electrode 6 and serves for more reliable measuring in the case of accretion formation. Known, however, are also probes 10 without guard electrode 7, as well as probes 10 of greater length, which protrude into the container.

Located between the electrodes 6, 7 and the insulation, as well as between the housing 8 and the insulation 9, there is, in each case, an intermediate space in the form of a joint 11. Each joint 11 is sealed with a sealing means 3. This is shown more exactly in FIG. 2. In the state of the art, each joint represents a problem location, since, depending on embodiment of the jointing, respectively the sealing, warping and/or corrosion can occur. The invention solves this problematic using a coating 4.

An advantageous embodiment of the method of the invention for manufacturing the corrosion resistant, process-facing surface of a measuring device is explained based on FIGS. 2-4 using the example of the probe 10 of FIG. 1.

FIG. 2 discloses, schematically, a section through the process-near portion of a probe 10 of FIG. 1 before the applying of the coating 4 onto the process-facing surface. Electrically conductive components 1 and electrically insulating components 2 alternate in this construction. Each joint 11 between a conductive component 1 and an insulating component 2 is filled by a sealing means 3. For example, the sealing means 3 is a glass seal or an electrically conductive solder or braze. The sealing means 3 bond with the components 1, 2 in such a manner that a sealed, process-facing surface is obtained. The hollow space contained in the housing 8 is sealed especially vacuum tightly relative to the process by the sealed, process-facing surface.

The insulating components 2 are produced with raised portions, which face the process and serve as sacrificial material 5, i.e. material removed in a later method step.

FIG. 3 shows the process-facing surface after the coating with tantalum. The coating 4 is applied in such a manner that it completely covers the process-facing surface. The thickness of the coating 4 lies, for example, between 5 and 100 micrometers, wherein the achievable thickness depends on the method, with which the tantalum coating 4 is deposited on the process-facing surface. In the case of a coating by depositing from a gas phase, for example, using TaBr5, a thickness of about 40 micrometer has proved to be advantageous.

A section from the construction of FIG. 3 after an additional method step is shown in FIG. 4. After applying the coating 4, such is sectionally removed. To do this, the sacrificial material 5 of the insulating components 2 is removed, for example, by grinding. The part of the coating 4 deposited on the sacrificial material 5 is removed together with the sacrificial material 5, so that only the edge region of the insulating component 2 remains coated. The edge region forms the transitional region to the sealing means 3.

The process-facing surface of the sealing means 3 remains completely coated, so that the sealing means 3 does not contact the process medium.

The conductive component 1 can remain completely coated; the coating 4 can, however, also be partially removed. In the latter case, the coating 4 remains at least in the edge regions, so that the transitional region between electrically conductive component 1 and sealing means 3 is covered by the tantalum coating 4.

A coating pattern such as that shown in FIG. 4 can, however, also be produced in alternative ways. One opportunity for this contains features including that a suitable mask is produced and positioned on the process-facing surface, so that in the subsequent depositing of the tantalum only those locations of the surface are coated, which are free of the mask. The manufacture of the insulating components 2 with removable, sacrificial material 5 is then not required. Another opportunity, in the case of which likewise no sacrificial material 5 is provided, contains features wherein the process-facing surface is first completely coated and the coating 4 then selectively removed in an additional step, for example, in an etching process.

The coating 4 of the invention is not limited to capacitive or conductive, fill level measuring devices. It is universally applicable where a joint 11 occurs between an electrically conductive component 1 and an insulating component 2 and the joint must remain sealed, so that no medium can penetrate into the joint 11. Some examples of further applications are presented in FIGS. 5-7.

FIG. 5 shows a section of a pressure sensor 20. Arranged in the metal housing 23 is a ceramic, capacitive, pressure measuring cell 22. The pressure measuring cell 22 is placed in the housing 23 in such a manner that the process pressure can act on the membrane 21 and the pressure measuring cell 22 is connected vacuum tightly with the housing 23. The connection is produced by the solder or braze 24. The coating 4 of the invention is applied on the process-facing surface of the pressure sensor 20, such that a part of the housing 23 and the membrane 21 are completely coated and, thus, the joint between these two parts and the solder or braze 24 are covered by a tantalum layer. Membrane 21 can also be spared the coating 4, or the coating 4 can be removed from the membrane. At least a narrow transitional region to the solder or braze 24 is, however, left covered by the coating 4.

FIG. 6 shows a radar measuring device 30 for continuous fill level measurement using a hollow conductor feedthrough. Microwaves are radiated via the supply element 33 into the hollow conductor 32 filled partially with a dielectric 34, from whence they move via the horn antenna 31 into the container 36, where, as incoming wave S, they strike the medium 37, are reflected by such, and are subsequently detected by the measuring device 30 as exiting wave R. The fill level is determinable from the travel time. Between horn antenna 31 and dielectric 34, a joint is located, for example, a joint sealed with a glass seal as sealing means 3. According to the invention, this is coated with a tantalum layer 35.

FIG. 7 shows a measuring device 40 with guided radar likewise applied for continuous fill level measurement. The waves are radiated here via a rod probe 41 into the container 36. Located in the region of the process connection is a coaxial feedthrough 42 for the rod probe 41. This includes a metal jacket 43, which also serves as ground potential, and a dielectric 44. The joints between rod probe 41 and the dielectric 44, and between the jacket 43 and the dielectric 44, are sealed with a sealing means 3 and, according to the invention, coated with tantalum. The sealing means around the rod probe 41, as well as the coating, are not shown, in view of the scale of the drawing. The coating is applied analogously to the example of an embodiment illustrated in FIG. 4.

### LIST OF REFERENCE CHARACTERS

1 electrically conductive component
2 electrically insulating component
3 sealing means
4 coating
5 sacrificial material
6 probe electrode
7 guard electrode
8 housing
9 insulation
10 capacitive/conductive probe
11 joint
20 pressure sensor
21 membrane
22 pressure measuring cell
23 housing
24 solder or braze
30 radar measuring device
31 horn antenna
32 hollow space
33 supply element
34 dielectric
35 tantalum coating
36 container
37 medium
40 measuring device utilizing guided radar
41 rod probe
42 feedthrough
43 jacket
44 dielectric

1-17. (canceled)

18. A measuring device, having:
at least one joint between a component of an electrically conductive material and a component of an electrically insulating material;
at least one corrosion resistant, process-facing surface; and
a sealing means;
wherein:
said process-facing surface is provided with a coating in such a manner that at least said sealing means, a transitional region between said conductive component and said sealing means and a transitional region between said insulating component and said sealing means are covered by said coating.

19. The measuring device as claimed in claim 18, wherein:
said coating comprises a transition metal, especially tantalum, gold, platinum, zirconium, titanium, as well as compounds of the transition metals, especially oxides, nitrides, fluorides.

20. The measuring device as claimed in claim 18, whereine:
said coating comprises an element of the carbon group, especially carbon, silicon, diamond-like carbon (DLC), as well as compounds of the carbon group, especially silicon carbide.

21. The measuring device as claimed in claim 18, wherein:
said coating is polycrystalline, amorphous, partially crystalline, or textured.

22. The measuring device as claimed in claim 18, wherein:
said electrically conductive component comprises a metal, a metal alloy or a conductive ceramic.

23. The measuring device as claimed in claim 18, wherein:
said insulating component comprises a ceramic material.

24. The measuring device as claimed in claim 18, wherein:
said sealing means comprises solder, braze or glass.

25. A method for manufacturing a corrosion resistant, process-facing surface of a measuring device, wherein at least one joint between a component of an electrically conductive material and a component of an electrically insulating material is sealed with a sealing means, comprising the step of:
providing a process-facing surface with a coating in such a manner that at least the sealing means, a transitional region between the conductive component and the sealing means and a transitional region between the insulating component and the sealing means are covered by the coating.

26. The method as claimed in claim 25, wherein:
the process-facing surface is completely coated in a first step, and the coating is sectionally removed in a second step, so that the insulating component is at least sectionally free of the coating.

27. The method as claimed in claim 26, wherein:
the coating is removed sectionally by removing material from the coated insulating component.

28. The method as claimed in claim 26, wherein:
the coating is sectionally removed by etching.

29. The method as claimed in claim 25, wherein:
only the process-facing surface of the sealing means, the transition region between the conductive component and the sealing means and the transition region between the insulating component and the sealing means are selectively coated.

30. The method as claimed in claim 25, wherein:
a coating between 5 and 100 micrometer thick is produced.

31. The method as claimed in claim 25, wherein:
the coating comprises a transition metal, especially tantalum, gold, platinum, zirconium, titanium, as well as compounds of the transition metals, especially oxides, nitrides, fluorides.

32. The method as claimed in claim 25, wherein:
the coating comprises an element of the carbon group, especially carbon, silicon, diamond-like carbon, as well as compounds of the carbon group, especially silicon carbide includes.

33. The method as claimed in claim 25, wherein:
the coating is polycrystalline, amorphous, partially crystalline, or textured.

34. The method as claimed in claim 25, wherein:
the coating is produced using the CVD (Chemical Vapor Deposition) and/or PVD (Physical Vapor Deposition) method.
